(19) United States
(12) Patent Application Publication
(10) Pub. No.: US 2020/0333215 A1
(43) Pub. Date: Oct. 22, 2020

(54) ENGINE DIAGNOSTIC SYSTEM, VEHICLE USED FOR THE ENGINE DIAGNOSTIC SYSTEM, AND ENGINE DIAGNOSING METHOD

(71) Applicant: TOYOTA JIDOSHA KABUSHIKI KAISHA, Toyota-shi (JP)

(72) Inventor: Toshio MAEDA, Toyota-shi (JP)

(73) Assignee: TOYOTA JIDOSHA KABUSHIKI KAISHA, Toyota-shi (JP)

(21) Appl. No.: 16/821,230

(22) Filed: Mar. 17, 2020

(30) Foreign Application Priority Data
Apr. 22, 2019 (JP) 2019-080855

(51) Int. Cl. G01M 15/05; G07C 5/08

(52) U.S. Cl. CPC G01M 15/05; G07C 5/0808; G07C 5/085

(57) ABSTRACT

An engine diagnostic system is configured to diagnose the degree of deterioration of an engine mounted on a vehicle on the basis of use frequency information, which is information related to frequency of use of each of a plurality of operational zones that are divided according to an engine rotational speed and an engine load factor. The engine diagnostic system includes a database configured to store, for each individual engine, the use frequency information of each operational zone. The use frequency information is acquired from a plurality of vehicles of the same model. The engine diagnostic system is configured to execute an evaluation process to calculate an evaluation value of the degree of deterioration of a designated engine on the basis of the use frequency information of each operational zone of each engine stored in the database.

### BACKGROUND

### 1. Field

The present disclosure relates to an engine diagnostic system, a vehicle used for the engine diagnostic system, and an engine diagnosing method.

### 2. Description of Related Art

The Japanese Laid-Open Patent Publication No. 2002-266617 discloses a device that calculates the degree of deterioration of engine oil on the basis of the frequency of use of each of operational zones that are divided according to the engine rotational speed and the engine load factor.

The degree of deterioration of an engine varies depending on the frequency of use of each operational zone. For example, in an engine in which a high-rotational speed and high-load zone is used frequently, the plastic parts and oil are exposed to high temperature, so that the degree of deterioration of the engine due to such a high-temperature environment is high. Also, in an engine in which a low-rotational speed and low-load zone is used frequently, deposit collected on the engine cylinders is not burned readily, so that the collected amount of such deposit increases. This increases the degree of deterioration of the engine due to collected deposit.

As such, information related to the frequencies of use of the respective operational zones are considered may be as an index of the degree of deterioration of the engine. To evaluate the degree of deterioration of the engine from the frequencies of use of the respective operational zones, the correlation between the frequency of use of the operational zones and the degrees of deterioration must be acquired in advance. However, since deterioration of an engine gradually progresses over a long period of time, the correlation cannot be easily acquired through experiments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an engine diagnostic system is provided that is configured to diagnose a degree of deterioration of an engine mounted on a vehicle on a basis of use frequency information, which is information related to frequency of use of each of a plurality of operational zones that are divided according to an engine rotational speed and an engine load factor. The engine diagnostic system includes a database configured to store, for each individual engine, the use frequency information of each operational zone. The use frequency information is acquired from a plurality of vehicles of a same model. The engine diagnostic system is configured to execute an evaluation process to calculate an evaluation value of a degree of deterioration of a designated engine on a basis of the use frequency information of each operational zone of each engine stored in the database.

The database of the engine diagnostic system amasses information related to frequencies of use of respective operational zones of a great number of engines mounted on vehicles of the same model. Comparison between the use frequency information of each operational zone of the engine to be diagnosed and those of other engines allows for evaluation of the relative degree of deterioration of the engine in relation to the other engines. Thus, the above-described engine diagnostic system is capable of obtaining, without setting evaluation standards for the degree of deterioration in advance, the evaluation value of the degree of deterioration of the engine to be diagnosed as a value that indicates the relative evaluation among the engines in which the use frequency information of the operational zones is stored in the database. Thus, the above-described engine diagnostic system is capable of properly diagnosing the degree of deterioration of the engine on the basis of the frequencies of use of the operational zones. The engine load factor is the ratio of the current cylinder inflow air amount to the cylinder inflow air amount when the throttle valve is fully opened at the current engine rotational speed.

A vehicle used for the above-described engine diagnostic system preferably includes a control module configured to calculate the use frequency information and execute transmission of the calculated use frequency information.

In another general aspect, an engine diagnostic method is provided that is used to diagnose a degree of deterioration of an engine mounted on a vehicle on a basis of use frequency information, which is information related to frequency of use of each of a plurality of operational zones that are divided according to an engine rotational speed and an engine load factor. The method includes: a first step of amassing the use frequency information of operational zones from multiple vehicles of a same model; a second step of, in response to input of individual identification information of an engine to be diagnosed, calculating an evaluation value of the degree of deterioration of the engine to be diagnosed on a basis of the use frequency information of the operational zones amassed in the first step; and diagnosing the degree of deterioration of the engine through the first step and the second step.

The first step amasses information related to frequencies of use of the respective operational zones of a great number of engines mounted on vehicles of the same model. Comparison between the use frequency information of the engine to be diagnosed and those of other engines allows for evaluation of the relative degree of deterioration of the engine in relation to the other engines. Thus, the above-described engine diagnosing method is capable of obtaining, without setting evaluation standards for the degree of deterioration in advance, the evaluation value of the degree of deterioration of the engine to be diagnosed as a value that indicates the relative evaluation among the engines in which the use frequency information of the operational zones has been amassed. Thus, the above-described engine diagnosing method is capable of properly diagnosing the degree of deterioration of the engine on the basis of the frequencies of use of the operational zones.

Other features and aspects will be apparent from the following detailed description, the drawings, and the claims.

### BRIEF DESCRIPTION OF THE DRAWINGS

FIG. 1 is a diagram schematically showing the configuration of an engine diagnostic system according to an embodiment.

FIG. 2 is a diagram showing divided operational zones.

FIG. 3 is a graph showing cumulative operational time in a specific operational zone of each vehicle and average values of cumulative operational time in the specific operational zone of all the vehicles.

FIG. 4 is a diagram schematically showing the configuration of an information distribution system that performs a service of distributing information in cooperation with the engine diagnostic system of the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

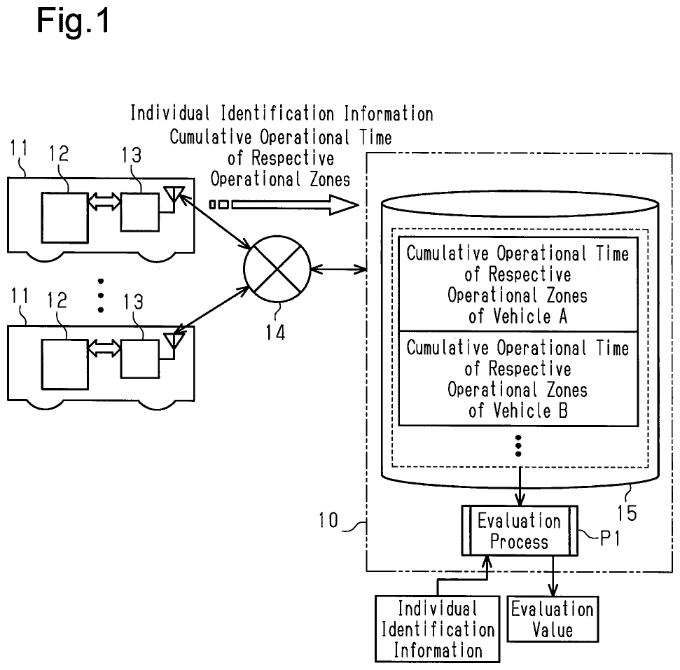

An engine diagnostic system 10, vehicles 11 used for the engine diagnostic system 10, and an engine diagnosing method according to an embodiment will now be described with reference to FIGS. 1 to 4.

First, the configuration of the engine diagnostic system 10 of the present embodiment will be described with reference to FIG. 1.

The engine diagnostic system 10 is a computer system that has a function of managing a database 15 and is configured as a system that diagnoses the degrees of deterioration of the engines 12 mounted on the vehicles 11 of the same model that are being managed.

Each of the vehicles 11 that are being managed by the engine diagnostic system 10 mounts a control unit 13, which is configured to perform various types of control including the control of the engine 12. The control unit 13 has a wireless communication function and is capable of transmitting and receiving data to and from the engine diagnostic system 10 via a mobile communication network 14.

The control unit 13 of each vehicle 11 calculates use frequency information, which is information related to the frequency of use of each operational zone of the engine 12.

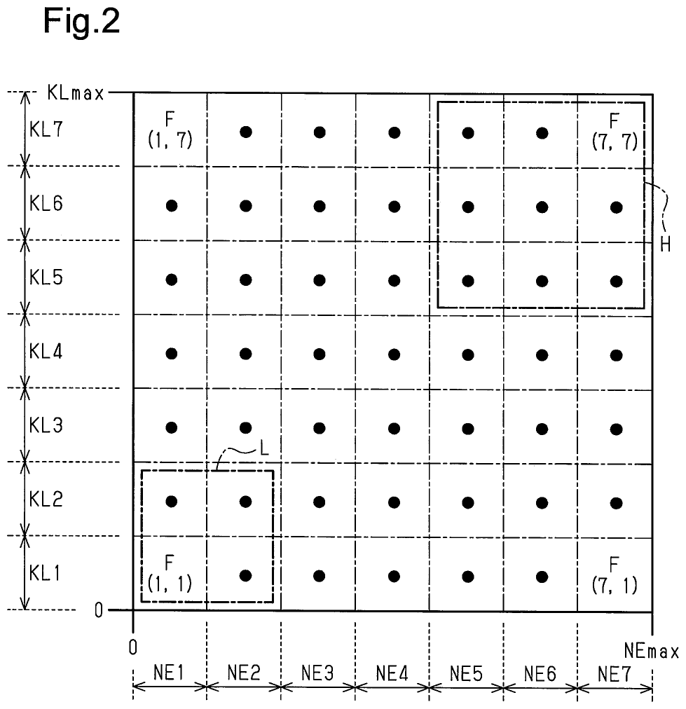

As shown in FIG. 2, in the present embodiment, the engine operational zone, which is defined by the engine rotational speed and the engine load factor, is divided into multiple operational zones, and the use frequency information is calculated for each operational zone. In the present embodiment, the cumulative operational time of each operational zone is used as a value indicating the use frequency information of each operational zone. The calculation of the cumulative operational time is started, for example, when the vehicle 11 is sold as a new car.

As one example, in the present embodiment, the rotational speed range from 0 to the maximum rotational speed NEmax achievable by the engine 12 is equally divided into seven ranges. Hereinbelow, the equally divided seven rotational speed ranges will be referred to, from the lowest rotational speed range to higher rotational speed ranges, a first speed range NE1, a second speed range NE2, a third speed range NE3, a fourth speed range NE4, a fifth speed range NE5, a sixth speed range NE6, and a seventh speed range NE7.

Likewise, the range of an engine load factor KL from 0 to the maximum load factor KLmax achievable by the engine 12 is equally divided into seven ranges. Hereinbelow, the equally divided seven load ranges will be referred to, from the lowest load range to higher load ranges, a first load range KL1, a second load range KL2, a third load range KL3, a fourth load range KL4, a fifth load range KL5, a sixth load range KL6, and a seventh load range KL7.

Each operational zone is represented by F(m, n) (where 1≤m≤7, 1≤n≤7), and the cumulative operational time is calculated for each operational zone F(m, n). For example, the cumulative operational time when the operational zone corresponds to the first speed range NE1 and the first load range KL1 is calculated as the use frequency information of the operational zone F(1, 1). Also, the cumulative operational time when the operational zone corresponds to the first speed range NE1 and the seventh load range KL7 is calculated as the use frequency information of the operational zone F(1, 7).

The control unit 13 periodically transmits data to the engine diagnostic system 10. In the data transmission, the current values of the cumulative operational time in the respective operational zones and individual identification information of the vehicle 11, such as the chassis number, are transmitted to the engine diagnostic system 10. In the present embodiment, the control unit 13 is configured to perform such data transmission to the engine diagnostic system 10 each time a predetermined period has elapsed.

The engine diagnostic system 10 includes a database 15. The database 15 stores the cumulative operational time of the respective operational zones of each vehicle 11, while associating the cumulative operational time with the individual identification information of each vehicle 11. Upon reception of the data transmitted by the control unit 13 of each vehicle 11, the engine diagnostic system 10 updates the cumulative operational time of the respective operational zones corresponding to the received individual identification information with the received data of the cumulative operational time. In this manner, the database 15 amasses the cumulative operational time of the respective operational zones in each vehicle 11 in the present embodiment.

Further, the engine diagnostic system 10 performs an evaluation process P1 in response to a diagnosis request for the engine 12 from the outside. A diagnosis request is made by designating the individual identification information of the vehicle 11 to be diagnosed. In the evaluation process P1, in response to input of the individual identification information that designates the vehicle 11 having the engine 12 to be diagnosed, the evaluation value of the degree of deterioration of the engine 12 mounted on the vehicle 11 is calculated, and the evaluation value is returned to the source of the diagnosis request. In the following description, the vehicle 11 designated as the subject of diagnosis will be referred to as a diagnosis subject vehicle.

The degree of deterioration of the engine 12 varies depending on the frequency of use of each operational zone. For example, in an engine 12 in which the operational zones in a high-rotational speed and high-load zone H shown in FIG. 2 are used frequently, the plastic parts and oil are exposed to high temperature, so that the degree of deterioration of the engine 12 due to such a high-temperature environment is high. Also, in an engine 12 in which the operational zones in a low-rotational speed and low-load zone L shown in FIG. 2 are used frequently, deposit collected on the engine cylinders is not burned readily so that the collected amount of such deposit increases. This increases the degree of deterioration of the engine 12 due to collected deposit. As such, the information related to the frequency of use of each operational zone is an index of the degree of deterioration of the engine 12. In the present embodiment, the operational zones in the high-rotational speed and high-load zone H are operational zones of which the speed range is the fifth speed range NE5 or higher and the load range is the fifth load range KL5 or higher. The operational zones in the low-rotational speed and low-load zone L are operational zones of which the speed range is the second speed range NE2 or lower and the load range is the second load range KL2 or lower. The extent of the operational zones in the high-rotational speed and high-load zone H and the extent of the operational zones in the low-rotational speed and low-load zone L may be changed.

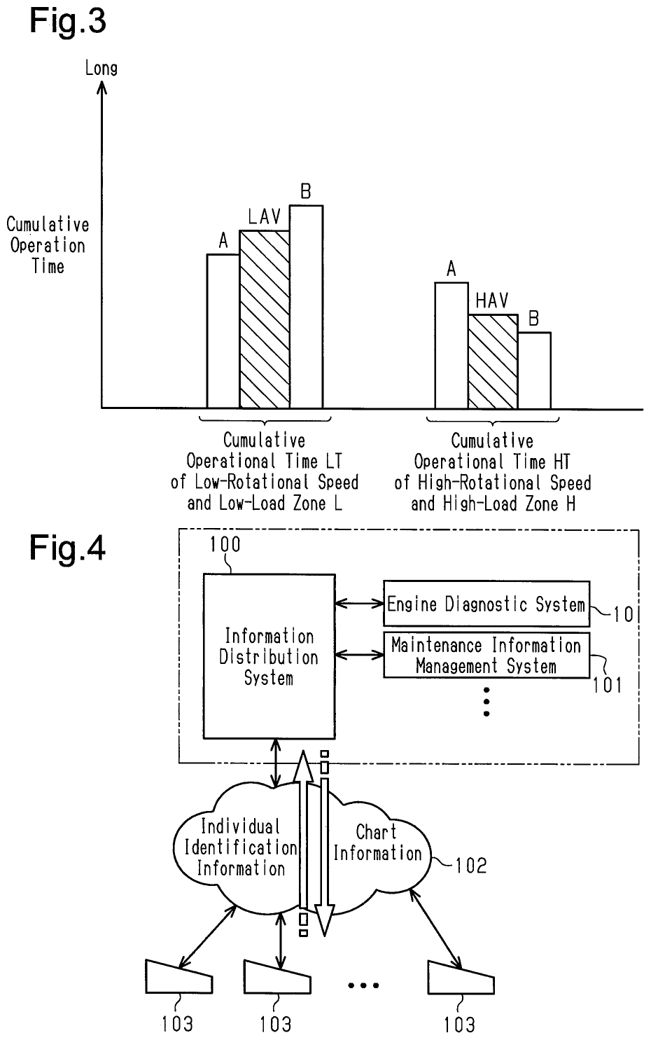

FIG. 3 shows the difference in a cumulative operational time LT of the low-rotational speed and low-load zone L and the difference in the cumulative operational time HT of the high-rotational speed and high-load zone H between two vehicles A and B of the same model. FIG. 3 also shows an average value LAV of the cumulative operational time LT of the low-rotational speed and low-load zone L and an average value HAV of the cumulative operational time HT of the high-rotational speed and high-load zone H of all the vehicles of the same model as the vehicles A and B. The cumulative operational time LT of the low-rotational speed and low-load zone L of the vehicles A and B is the total of the cumulative operational time in the operational zones in the low-rotational speed and low-load zone L calculated for each of the vehicles A and B. Likewise, the cumulative operational time HT of the high-rotational speed and high-load zone H of the vehicles A and B is the total of the cumulative operational time in the operational zones in the high-rotational speed and high-load zone H calculated for each of the vehicles A and B.

The cumulative operational time LT of the low-rotational speed and low-load zone L of the vehicle A is shorter than the average value LAV of all the vehicles of the same model. The cumulative operational time LT in the low-rotational speed and low-load zone L of the vehicle B is longer than the average value LAV of all the vehicles of the same model. This indicates that the degree of deterioration due to collected deposit of the engine 12 mounted on the vehicle A is lower than the average of all the vehicles of the same model, and that the degree of deterioration due to collected deposit of the engine 12 mounted on the vehicle B is higher than the average of all the vehicles of the same model.

The cumulative operational time HT of the high-rotational speed and high-load zone H of the vehicle A is longer than the average value HAV of all the vehicles of the same model. The cumulative operational time HT of the high-rotational speed and high-load zone H of the vehicle B is shorter than the average value HAV of all the vehicles of the same model. This indicates that the degree of deterioration due to a high-temperature environment of the engine 12 mounted on the vehicle A is higher than the average of all the vehicles of the same model, and that the degree of deterioration due to a high-temperature environment of the engine 12 mounted on the vehicle B is lower than the average of all the vehicles of the same model.

In this manner, the comparison of the use frequency information amassed in the database 15 allows for evaluation of the degree of deterioration of the engine 12, which is relative evaluation among all the vehicles of the same model.

The engine diagnostic system 10 of the present embodiment calculates a value discussed below as the evaluation value of the degree of deterioration of the engine 12 in the evaluation process P1. That is, in the present embodiment, the engine diagnostic system 10 calculates the average value LAV of the low-rotational speed and low-load zone L of all the vehicles of the same model and the average value HAV of the high-rotational speed and high-load zone H of all the vehicles of the same model on the basis of the cumulative operational time of the respective operational zones of the vehicles 11, which have been amassed in the database 15. The engine diagnostic system 10 calculates the difference between the average value LAV of all the vehicles and the cumulative operational time LT of the vehicle to be diagnosed as the evaluation value of the degree of deterioration due to collected deposit of the engine 12 mounted on that vehicle. The engine diagnostic system 10 also calculates the difference between the average value HAV of all the vehicles and the cumulative operational time HT of the vehicle to be diagnosed as the evaluation value of the degree of deterioration due to a high-temperature environment of the engine 12 mounted on that vehicle.

The values of the thus calculated differences represent relative evaluation of the degree of deterioration of the engine 12 mounted on the vehicle to be diagnosed among the vehicles of the same model.

Instead of using the difference, the engine diagnostic system 10 may calculate, as the evaluation value of the degree of deterioration of the engine 12, the grade of the degree of deterioration that is determined on the basis of the difference. In either case, any value can be used as the evaluation value of the degree of deterioration of the engine 12 as long as that value expresses, as the relative evaluation among the vehicles 11 of the same model, the degree of deterioration of the engine 12 of the vehicle to be diagnosed that is obtained from the use frequency information of the operational zones amassed in the database 15.

In the present embodiment, the diagnosis of the degree of deterioration of the engine 12 is performed through a first step and a second step described below. That is, the diagnosing method includes: a first step of amassing use frequency information of operational zones from multiple vehicles 11 of the same model; and a second step of, in response to input of individual identification information of an engine 12 to be diagnosed, calculating an evaluation value of the degree of deterioration of the engine 12 to be diagnosed on the basis of the use frequency information of the operational zones amassed in the first step.

The engine diagnostic system 10 can be used in an information distribution service for used car auction participants such as sellers, bidders, and appraisers. In a used car auction market, information regarding listed vehicles such as the model, the total traveled distance, defacement on the exterior, and damaged portions is shown to the bidders, and the bidders determine bid prices on the basis of the information. The quality of the condition of the engine, that is, the degree of deterioration of the engine is also an important factor in determining the value of the vehicle. However, in the current situation, the bidders have to determine the condition of the engine indirectly from the total traveled distance. Thus, in the current situation, the value of the vehicle of which the engine condition is good relative to the total traveled distance cannot be properly evaluated. The above-described information distribution service offers to participants of used car auction information regarding vehicles including the engine conditions.

FIG. 4 shows the configuration of an information distribution system 100, which performs such an information distribution service. The information distribution system 100 includes a computer system having a web server function. Also, the information distribution system 100 is connected to various types of vehicle information management systems, which manage information related vehicles. The engine diagnostic system 10 of the present embodiment is also one of such vehicle information management systems. The vehicle information management systems other than the engine diagnostic system 10 include a maintenance information management system 101, which manages information related to maintenance history of each vehicle. The maintenance information management system 101 stores information related to maintenance history of each vehicle associated with individual identification information. The information distribution system 100 is connected to computer terminals 103 operated by participants of a used car auction through an Internet connection 102.

A participant of the used car auction sends the individual identification information of a listed vehicle to the information distribution system 100 using the computer terminal 103. On the basis of the received individual identification information, the information distribution system 100 acquires information related to the corresponding vehicle from the vehicle information management system. At this time, the information distribution system 100 acquires the evaluation value of the degree of deterioration of the engine 12 of the corresponding vehicle from the engine diagnostic system 10. The information distribution system 100 acquires, as the evaluation value of the degree of deterioration, for example, whether the engine rotational speed has exceeded a permissible rotational speed, that is, whether there is a history of over-revving. The information distribution system 100 creates a vehicle chart on the basis of the acquired information and delivers the individual identification information to the computer terminal 103 that is the source of the individual identification information. The vehicle chart includes various types of information that can be used to determine the bidding price, such as the tendency of driving of the former drivers of the vehicle, the evaluation of the engine, the evaluation of the driving battery, the maintenance condition, the failure history, the history of accidents, and whether the vehicle is a one-owner car. The evaluation value of the degree of deterioration of the engine 12 acquired from the engine diagnostic system 10 is also used to create the vehicle chart.

The present embodiment described above has the following advantages.

(1) The engine diagnostic system 10 collects the use frequency information of each operational zone of the engines 12 mounted on the vehicles of the same model, and calculates the evaluation values of the degree of deterioration of the engines 12 on the basis of the collected use frequency information. This allows for the evaluation of the degree of deterioration of each engine 12, which is relative evaluation among the vehicles of the same model.

(2) The embodiment allows for the evaluation of the degree of deterioration of each engine 12, which is relative evaluation among the vehicles of the same model. This allows for proper diagnosis without setting evaluation standards for the degree of deterioration of the engine 12.

The above-described embodiment may be modified as follows. The above-described embodiment and the following modifications can be combined as long as the combined modifications remain technically consistent with each other.

In the present embodiment, data such as use frequency information is transmitted from the vehicle to the engine diagnostic system each time a predetermined period has elapsed. However, the data transmission may be performed at other timing. For example, the data transmission may be performed each time the vehicle travels a predetermined distance. Also, the engine diagnostic system may determine the timing the data transmission. In this case, the data transmission from the vehicle is performed in response to a request from the engine diagnostic system.

In the above-described embodiment, the degree of deterioration of the engine 12 is diagnosed on the basis of the cumulative operational time LT of the low-rotational speed and low-load zone L and the cumulative operational time HT of the high-rotational speed and high-load zone H. Instead, the degree of deterioration of the engine 12 may be diagnosed on the basis of the cumulative operational time of other operational zones. Further, the degree of deterioration of the engine 12 may be diagnosed on the basis of the cumulative operational time of each of the divided operational zones.

In the above-described embodiment, the cumulative operational time of each operational zone is used as a value indicating the use frequency information of each operational zone. However, other values may be used. For example, as a value indicating the use frequency information of each operational zone, the ratio of the cumulative operational time of each operational zone to the total operational time of the engine may be used.

In the above-described embodiment, when the engine operational zone, which is defined by the engine rotational speed and the engine load factor, is divided into multiple operational zones, the rotational speed range of the engine rotational speed NE and the load range of the engine load factor KL are each equally divided into seven sections. The number of equally divided sections may be changed. Also, the rotational speed range of the engine rotational speed NE and the load range of the engine load factor KL do not necessarily need to be equally divided, but may be unequally divided. For example, an operational zone that greatly affects the degree of wear of the engine may be divided into an increased number of sections as compared with other operational zones.

The engine diagnostic system of the above-described embodiment can be used for purposes other than an information distribution service for used car auction participants. The engine diagnostic system may be used for an information distribution service that provides, to vehicle maintenance providers, evaluation values of the degree of deterioration obtained by the engine diagnostic system 10 as standards for determining time for engine maintenance or replacement of parts.

The engine diagnostic system 10 is not limited to a device that includes a CPU and a memory and executes software processing. For example, at least part of the processes executed by the software in the above-described embodiment may be executed by hardware circuits dedicated to the execution of these processes (such as ASIC). That is, the engine diagnostic system 10 may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including a processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine diagnostic system configured to diagnose a degree of deterioration of an engine mounted on a vehicle on a basis of use frequency information, which is information related to frequency of use of each of a plurality of operational zones that are divided according to an engine rotational speed and an engine load factor, wherein
the engine diagnostic system comprises a database configured to store, for each individual engine, the use frequency information of each operational zone, the use frequency information being acquired from a plurality of vehicles of a same model, and
the engine diagnostic system is configured to execute an evaluation process to calculate an evaluation value of a degree of deterioration of a designated engine on a basis of the use frequency information of each operational zone of each engine stored in the database.

2. A vehicle used for an engine diagnostic system, wherein
the engine diagnostic system is configured to diagnose a degree of deterioration of an engine mounted on the vehicle on a basis of use frequency information, which is information related to frequency of use of each of a plurality of operational zones that are divided according to an engine rotational speed and an engine load factor,
the engine diagnostic system includes a database configured to store, for each individual engine, the use frequency information of each operational zone, the use frequency information being acquired from a plurality of vehicles of a same model,
the engine diagnostic system is configured to execute an evaluation process to calculate an evaluation value of a degree of deterioration of a designated engine on a basis of the use frequency information of each operational zone of each engine stored in the database, and
the vehicle includes a control module configured to calculate the use frequency information and execute transmission of the calculated use frequency information.

3. An engine diagnostic method of diagnosing a degree of deterioration of an engine mounted on a vehicle on a basis of use frequency information, which is information related to frequency of use of each of a plurality of operational zones that are divided according to an engine rotational speed and an engine load factor, the method comprising:
a first step of amassing the use frequency information of operational zones from multiple vehicles of a same model;
a second step of, in response to input of individual identification information of an engine to be diagnosed, calculating an evaluation value of the degree of deterioration of the engine to be diagnosed on a basis of the use frequency information of the operational zones amassed in the first step; and
diagnosing the degree of deterioration of the engine through the first step and the second step.
